(19) United States
(12) Patent Application Publication
(10) Pub. No.: US 2006/0066897 A1
(43) Pub. Date: Mar. 30, 2006

(54) Imaging and recording system

(75) Inventors: Tomoyuki Takada, Tokyo (JP); Noriyuki Suzuki, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/227,070

(22) Filed: Sep. 16, 2005

(30) Foreign Application Priority Data
Sep. 24, 2004 (JP) 2004-277756

(51) Int. Cl. G06F 3/12

(52) U.S. Cl. 358/1.15

(57) ABSTRACT

There is provided an imaging and recording system including an imaging apparatus and a recording apparatus. The imaging apparatus receives an output bit rate instruction which is issued by the recording apparatus and instructs the imaging apparatus on the first bit rate of image data to be output from the imaging apparatus. The imaging apparatus converts a sensed image into image data of a predetermined bit rate on the basis of the received output bit rate instruction, and outputs the image data to the recording apparatus. The recording apparatus has a disk type recording medium. The recording apparatus calculates the second bit rate which allows recording on the disk type recording medium, calculates the first bit rate of image data to be output from the imaging apparatus on the basis of the second bit rate, and issues the output bit rate instruction to the imaging apparatus. The recording apparatus receives the image data output from the imaging apparatus, and records the image data on the disk type recording medium.

### FIELD OF THE INVENTION

The present invention relates to an imaging and recording system having an imaging apparatus and a recording apparatus.

### BACKGROUND OF THE INVENTION

Imaging and recording systems such as a monitoring system have widely employed, as a recording medium of motion picture data, a hard disk which achieves a high speed, large capacity, and low bit cost.

A hard disk records input data as a magnetic signal on an internal magnetic disk. In general, data is desirably recorded/played back on/from a relatively large area which is physically continuous on a magnetic disk, in order to record/play back, on/from a hard disk, data of which a high bit rate and isochronism are requested, like motion picture data. However, such a relatively large area which is physically continuous cannot always be reserved in recording data on a hard disk.

In this situation, Japanese Patent Laid-Open No. 2001-67805 discloses a recording apparatus which controls the recording apparatus itself on the basis of management information on an unused recording area. In this reference, the recording apparatus detects an unused area on a recording medium, and calculates a recording enable time corresponding to a predetermined bit rate on the basis of the recording capacity of each detected unused area. Further, the recording apparatus displays the calculated recording enable time on a display means.

Recently, as digital motion picture input devices such as a digital video camera and network camera decrease in cost and prevail, user requests for the motion picture recording function vary. As disclosed in Japanese Patent Laid-Open No. 2001-67805, the user may want to display the recording enable time of a recording medium on a display means and use the recording enable time as a criterion for selecting the bit rate of a motion picture. The user may also want to change the bit rate of a motion picture in accordance with the state of an unused area on a recording medium and record data at a bit rate as high as possible while preventing a recording failure such as frame omission.

These demands are strong particularly in, e.g., a monitoring system which is often used continuously for a long time while the user is away from the recording apparatus. However, the prior art as disclosed in Japanese Patent Laid-Open No. 2001-67805 cannot implement a configuration which satisfies these demands.

### SUMMARY OF THE INVENTION

The present invention has been made in consideration of the conventional situation, and has as its object to provide an imaging and recording system which can change the bit rate in accordance with the state of an unused area in the hard disk of a recording apparatus and record data at a bit rate as high as possible while preventing a recording failure such as frame omission.

According to the present invention, the foregoing object is attained by providing an imaging and recording system including an imaging apparatus and a recording apparatus, wherein

the imaging apparatus comprises:
first receiving means for receiving an output bit rate instruction which is issued by the recording apparatus and instructs the imaging apparatus on a first bit rate of image data to be output from the imaging apparatus; and
output means for converting a sensed image into image data of a predetermined bit rate on the basis of the output bit rate instruction received by the first receiving means, and outputting the image data to the recording apparatus, and

the recording apparatus comprises:
a disk type recording medium;
first issue means for calculating a second bit rate recording enable on the disk type recording medium, calculating the first bit rate of image data to be output from the imaging apparatus on the basis of the second bit rate, and issuing the output bit rate instruction to the imaging apparatus; and
recording means for receiving the image data output from the imaging apparatus and recording the image data on the disk type recording medium.

In a preferred embodiment,

the imaging apparatus further comprises second receiving means for receiving an output data amount instruction which is issued by the recording apparatus and instructs the imaging apparatus on a first data amount of image data to be output from the imaging apparatus,

the output means outputs image data at the predetermined bit rate by a data amount based on the output data amount instruction received by the second receiving means,

the recording apparatus further comprises
reserving means for reserving a recording area of a predetermined amount in the disk type recording medium, and
second issue means for calculating a data amount of image data to be output from the imaging apparatus on the basis of a recording capacity of the recording area of the predetermined amount that is reserved by the reserving means, and issuing the output data amount instruction to the imaging apparatus,

the first issue means calculates a second bit rate which allows recording on the disk type recording medium in the recording area of the predetermined amount that is reserved by the reserving means, and

the recording means records image data received from the imaging apparatus in the recording area of the predetermined amount that is reserved by the reserving means.

In a preferred embodiment,

the imaging apparatus further comprises third issue means for issuing an image recording request which requests the recording apparatus to record image data output from the imaging apparatus,

the recording apparatus further comprises third receiving means for receiving the image recording request issued by the imaging apparatus, and

the first issue means calculates the first bit rate of image data to be output from the imaging apparatus on the basis of the number of imaging apparatuses which have issued the image recording request received by the third receiving means.

In a preferred embodiment,

the imaging apparatus further comprises third issue means for issuing an image recording request which requests the recording apparatus to record image data output from the imaging apparatus,

the recording apparatus further comprises third receiving means for receiving the image recording request issued by the imaging apparatus,

the first issue means calculates the first bit rate of image data to be output from the imaging apparatus on the basis of the number of imaging apparatuses which have issued the image recording request received by the third receiving means, and

the second issue means calculates the data amount of image data to be output from the imaging apparatus on the basis of the number of imaging apparatuses which have issued the image recording request received by the third receiving means.

In a preferred embodiment,

the disk type recording medium includes a plurality of disk type recording media, and

the first issue means calculates the second bit rate which allows recording on the disk type recording medium on the basis of a configuration of the plurality of disk type recording media, and calculates the first bit rate of image data to be output from the imaging apparatus on the basis of the second bit rate.

In a preferred embodiment,

the disk type recording medium includes a plurality of disk type recording media,

the first issue means calculates the second bit rate which allows recording on the disk type recording medium on the basis of a configuration of the plurality of disk type recording media, and calculates the first bit rate of image data to be output from the imaging apparatus on the basis of the second bit rate, and

the second issue means calculates the data amount of image data to be output from the imaging apparatus on the basis of the configuration of the plurality of disk type recording media.

In a preferred embodiment,

the plurality of recording media are configured with redundancy, and

the first issue means calculates the second bit rate which allows recording on the disk type recording medium on the basis of a state representing whether the plurality of disk type recording media are during a reconstructing process, and calculates the first bit rate of image data to be output from the imaging apparatus on the basis of the second bit rate.

In a preferred embodiment,

the plurality of recording media are configured with redundancy,

the first issue means calculates the second bit rate which allows recording on the disk type recording medium on the basis of a state representing whether the plurality of disk type recording media are during a reconstructing process, and calculates the first bit rate of image data to be output from the imaging apparatus on the basis of the second bit rate, and

the second issue means calculates the data amount of image data to be output from the imaging apparatus on the basis of the state representing whether the plurality of disk type recording media are during a reconstructing process.

According to the present invention, the foregoing object is attained by providing an imaging apparatus which is connected to a recording apparatus, comprising:

receiving means for receiving an output bit rate instruction which is issued by the recording apparatus and instructs the imaging apparatus on a first bit rate of image data to be output from the imaging apparatus; and

output means for converting a sensed image into image data of a predetermined bit rate on the basis of the output bit rate instruction received by the receiving means, and outputting the image data to the recording apparatus,

wherein the first bit rate is calculated on the basis of a second bit rate which is calculated by the recording apparatus and allows recording on a disk type recording medium.

According to the present invention, the foregoing object is attained by providing an imaging a recording apparatus which is connected to an imaging apparatus, comprising:

a disk type recording medium;

issue means for calculating a second bit rate which allows recording on the disk type recording medium, calculating a first bit rate of image data to be output from the imaging apparatus on the basis of the second bit rate, and issuing an output bit rate instruction to the imaging apparatus; and

recording means for receiving the image data output from the imaging apparatus and recording the image data on the disk type recording medium.

According to the present invention, the foregoing object is attained by providing an imaging a method of controlling an imaging apparatus which is connected to a recording apparatus, comprising:

a receiving step of receiving an output bit rate instruction which is issued by the recording apparatus and instructs the imaging apparatus on a first bit rate of image data to be output from the imaging apparatus; and

an output step of converting a sensed image into image data of a predetermined bit rate on the basis of the output bit rate instruction received in the receiving step, and outputting the image data to the recording apparatus,

wherein the first bit rate is calculated on the basis of a second bit rate which is calculated by the recording apparatus and allows recording on a disk type recording medium.

According to the present invention, the foregoing object is attained by providing an imaging a method of controlling a recording apparatus which is connected to an imaging apparatus and has a disk type recording medium, comprising:

an issue step of calculating a second bit rate recording enable on the disk type recording medium, calculating a first bit rate of image data to be output from the imaging apparatus on the basis of the second bit rate, and issuing an output bit rate instruction to the imaging apparatus; and

a recording step of receiving the image data output from the imaging apparatus and recording the image data on the disk type recording medium.

According to the present invention, the foregoing object is attained by providing an imaging a program for causing a computer to execute control of an imaging apparatus which is connected to a recording apparatus, comprising:

a receiving step of receiving an output bit rate instruction which is issued by the recording apparatus and instructs the imaging apparatus on a first bit rate of image data to be output from the imaging apparatus; and

an output step of converting a sensed image into image data of a predetermined bit rate on the basis of the output bit rate instruction received in the receiving step, and outputting the image data to the recording apparatus,

wherein the first bit rate is calculated on the basis of a second bit rate which is calculated by the recording apparatus and allows recording on a disk type recording medium.

According to the present invention, the foregoing object is attained by providing an imaging a program for causing a computer to execute control of a recording apparatus which is connected to an imaging apparatus and has a disk type recording medium, comprising:

an issue step of calculating a second bit rate recording enable on the disk type recording medium, calculating a first bit rate of image data to be output from the imaging apparatus on the basis of the second bit rate, and issuing an output bit rate instruction to the imaging apparatus; and

a recording step of receiving the image data output from the imaging apparatus and recording the image data on the disk type recording medium.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing an imaging and recording system according to the first embodiment of the present invention;

FIG. 2 is a flowchart showing operation of an imaging apparatus according to the first embodiment of the present invention;

FIG. 3 is a flowchart showing operation of a recording apparatus according to the first embodiment of the present invention;

FIG. 4 is a view schematically showing a storage area in an HDD according to the first embodiment of the present invention;

FIG. 5 is a table showing an example of a parameter table according to the first embodiment of the present invention;

FIG. 6 is a block diagram showing an imaging and recording system according to the second embodiment of the present invention;

FIGS. 7A and 7B are flowcharts showing operation of a recording apparatus according to the second embodiment of the present invention; and

FIG. 8 is a view schematically showing a storage area in an HDD according to the second embodiment of the present invention.

### DETAILED DESCRIPTION OF THE PREFERRED EMBODIMENTS

Preferred embodiments of the present invention will be described in detail in accordance with the accompanying drawings.

### First Embodiment

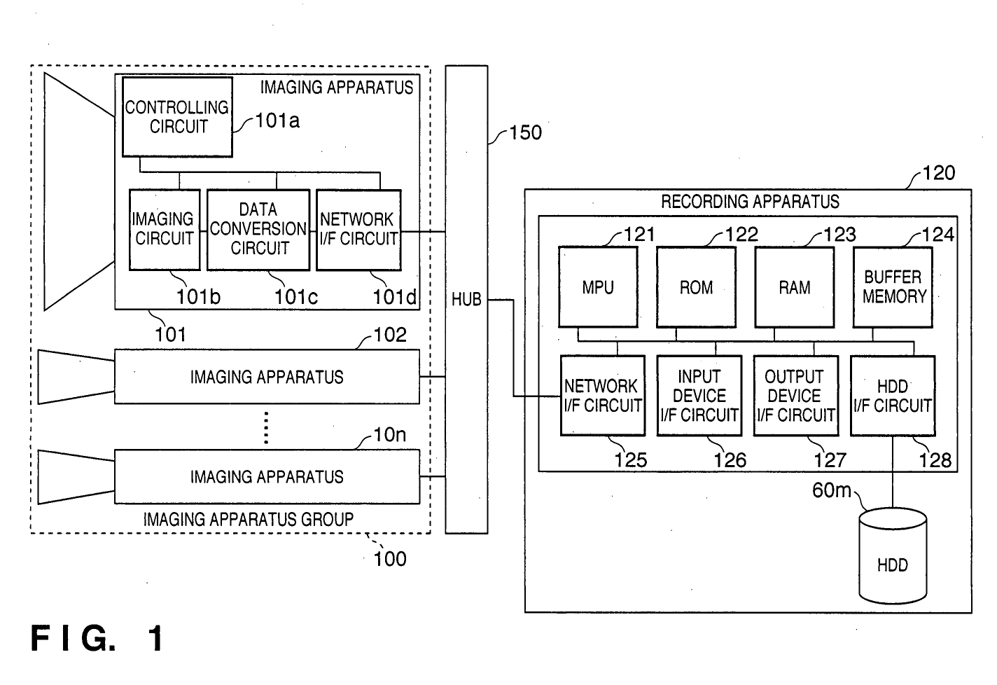

FIG. 1 is a block diagram showing an imaging and recording system according to the present invention. The imaging and recording system comprises an imaging apparatus group 100, recording apparatus 120, and hub 150.

The imaging apparatus group 100 includes n imaging apparatuses (network cameras) 101 to 10n. The imaging apparatus 101 is made up of a controlling circuit 101a, imaging circuit 101b, data conversion circuit 101c, and network interface (I/F) circuit 101d. The controlling circuit 101a controls operation of each building component of the imaging apparatus 101. The imaging circuit 101b receives an optical signal by a charge-coupled device (CCD) at a timing designated by the controlling circuit 101a. The imaging circuit 101b converts the optical signal into an electrical signal, amplifies the electrical signal, analog-to-digital-converts (A/D-converts) the signal, and transmits the digital signal to the data conversion circuit 101c.

The data conversion circuit 101c compresses the digital signal received from the imaging circuit 101b in accordance with a predetermined image compression standard on the basis of an instruction from the controlling circuit 101a. The data conversion circuit 101c then converts the compressed signal, and transmits it to the network interface circuit 101d. The image compression standard includes, e.g., MPEG2, MPEG4, and Motion JPEG. The network interface circuit 101d controls data input/output from/to a network. The network interface circuit 101d transmits, to a network, motion picture data which is compressed and converted by the data conversion circuit 101c. The imaging apparatuses 102 to 10n also have the same configuration as that of the imaging apparatus 101.

The recording apparatus 120 is comprised of a microprocessor (MPU) 121, read only memory (ROM) 122, random access memory (RAM) 123, buffer memory 124, network interface (I/F) circuit 125, input device interface (I/F) circuit 126, output device interface (I/F) circuit 127, hard disk interface (HDD I/F) circuit 128, and hard disk (HDD) 129. The MPU 121 executes a program to control various arithmetic operations and operation of various building components of the recording apparatus 120. The ROM 122 stores a program executed by the MPU 121. The RAM 123 temporarily stores data in executing a program by the MPU 121.

When data is transferred between an input/output device, a network, and the HDD 129, the buffer memory 124 temporarily stores data and absorbs temporal variations in data amount transferred between them. The network interface circuit 125 controls input/output of data from/to a network. The input device interface circuit 126 controls input of data from an input device such as a mouse or keyboard. The output device interface circuit 127 controls output of data to an output device such as a display or printer. The hard disk interface circuit 128 controls input/output of data to/from the HDD 129. The HDD 129 stores data input/output from/to an input/output device and network, and data generated by the MPU 121.

The hub 150 connects the imaging apparatuses 101 to 10n and the recording apparatus 120 to form a network.

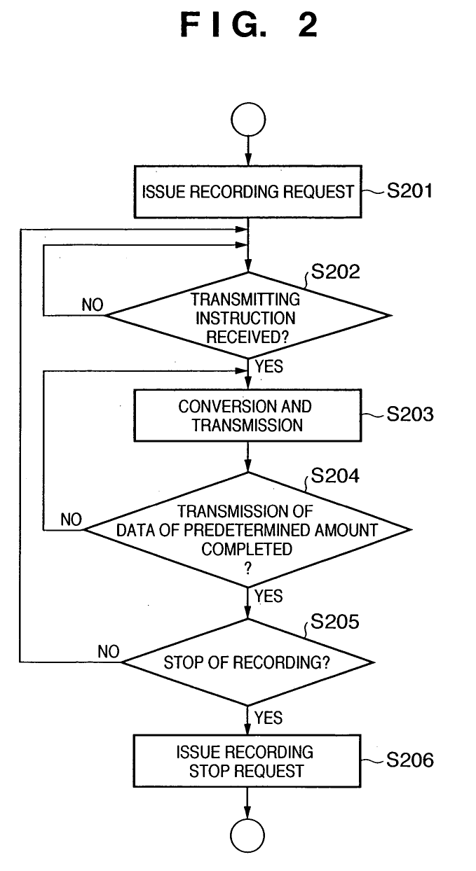

Imaging and recording operations of the imaging and recording apparatuses according to the present invention will be explained with reference to FIGS. 2 to 5.

FIG. 2 is a flowchart showing operation of the imaging apparatuses 101 to 10n. Operation of the imaging apparatuses 101 to 10n will be explained by typifying the imaging apparatus 101 among the imaging apparatuses 101 to 10n.

In step S201, the imaging apparatus 101 issues to the recording apparatus 120 a data recording request which requests recording of motion picture data to be transmitted from the imaging apparatus 101. In step S202, the imaging apparatus 101 waits for reception of a data transmitting instruction from the recording apparatus 120 that instructs the imaging apparatus 101 to transmit data containing information on the bit rate and data amount of motion picture data to be transmitted.

If the imaging apparatus 101 receives the data transmitting instruction in step S202, the imaging apparatus 101 executes a process from step S203. In step S203, the data conversion circuit 101c of the imaging apparatus 101 compresses and converts image data sensed by the imaging circuit 101b to a bit rate designated by the data transmitting instruction. The imaging apparatus 101 keeps transmitting data to the recording apparatus 120 until transmission of data of a predetermined data amount designated by the data transmitting instruction is completed (step S204).

If the imaging apparatus 101 completes transmission of data of the predetermined data amount in step S204 and is to continue recording by the recording apparatus 120 in step S205, the flow returns to step S202. If the imaging apparatus 101 is to stop recording, the imaging apparatus 101 issues to the recording apparatus 120 in step S206 a data recording stop request to request the recording apparatus 120 to stop recording of motion picture data transmitted from the imaging apparatus 101, and then the process ends.

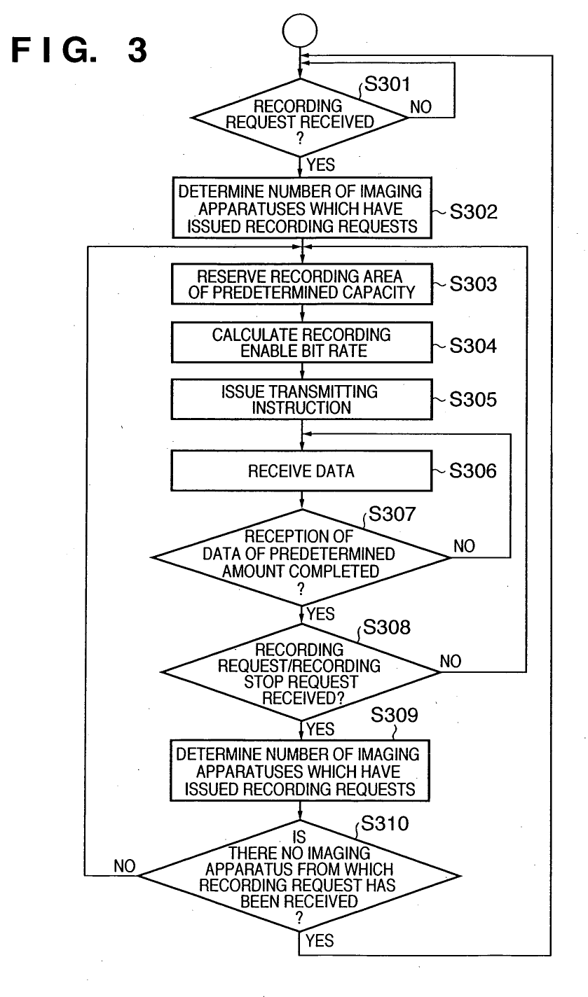

FIG. 3 is a flowchart showing operation of the recording apparatus 120.

In step S301, the recording apparatus 120 waits for reception of a data recording request from one or a plurality of imaging apparatuses 101 to 10n.

If the recording apparatus 120 receives a data recording request in step S301, the MPU 121 of the recording apparatus 120 determines in step S302 the number of imaging apparatuses which have issued data recording requests.

In step S303, the MPU 121 of the recording apparatus 120 searches the storage area of the HDD 129 for an unused area, and reserves a recording area of a predetermined capacity. The capacity of the recording area to be reserved is desirably decided on the basis of the allowance of latency which is generated by a process in steps S303 and S304 (to be described later). Alternatively, the capacity of the recording area to be reserved is desirably decided on the basis of the allowance of overhead which is generated upon executing a process in steps S305 to S308 (to be described later) a plurality of number of times.

In step S304, the MPU 121 of the recording apparatus 120 calculates a recording enable bit rate per imaging apparatus in the reserved recording area and a recording capacity per imaging apparatus in the reserved recording area. A method of calculating the bit rate and recording capacity will be exemplified later.

In step S305, the recording apparatus 120 issues, to the imaging apparatus which has issued the data recording request, a data transmitting instruction containing information on the recording enable bit rate and recording capacity per imaging apparatus in the reserved recording area. The recording enable bit rate is the bit rate of motion picture data to be transmitted from the imaging apparatus. The recording capacity is the data amount of motion picture data to be transmitted from the imaging apparatus.

In steps S306 and S307, the recording apparatus 120 keeps receiving data until data of the recording capacity per imaging apparatus in the reserved recording area is received from each imaging apparatus which has issued the data recording request. The recording apparatus 120 stores the received data in the buffer memory 124, and then records the data from the buffer memory 124 to the reserved recording area in the HDD 129.

In step S308, the recording apparatus 120 determines whether new data recording requests or data recording stop requests have arrived from the imaging apparatuses 101 to 10n. This determination can be implemented such that, for example, when the MPU 121 detects a data recording request or data recording stop request in processing a packet coming from a network, the request is buffered.

If neither new data recording request nor data recording stop request has arrived in step S308, the flow returns to step S303. If a new data recording request or data recording stop request has arrived in step S308, the MPU 121 of the recording apparatus 120 determines in steps S309 and S310 the number of imaging apparatuses from which data recording requests have been received at present.

If at least one imaging apparatus from which a data recording request has been received exists in step S310, the flow returns to step S303. If an imaging apparatus from which a data recording request has been received does not exist, the flow returns to step S301.

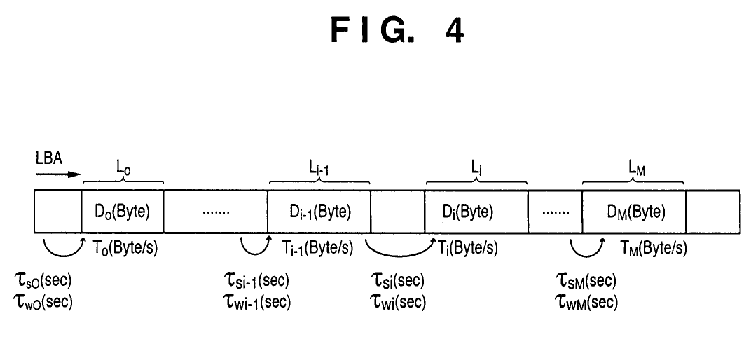

FIG. 4 is a view schematically showing a storage area in the HDD 129. A method of calculating a recording enable bit rate and recording capacity per imaging apparatus in the reserved recording area in step S304 will be exemplified with reference to FIG. 4.

In FIG. 4, Li (i=0, 1, . . . , M) represents a continuous recording area which is reserved in step S303, Di represents the size (bytes) of the recording area Li, and Ti represents a sustain transfer rate (bytes/s) in the recording area Li. Also, τsi represents a head seek time (sec) for moving the recording head of the HDD 129 to a track including a sector on which data is first recorded in the recording area Li, and τwi represents a rotation wait time until a magnetic disk rotates and the recording head reaches a target sector after the recording head moves to a track including the sector on which data is first recorded in the recording area Li.

A recording enable bit rate T/N (bytes/s) per imaging apparatus in the reserved recording area can be substantially calculated by
T/N=(α*ΣiDi/Σi(τsi+τwi+Di/Ti))/N (1)
(0<α≦1)

where α is the safety factor which is properly decided from the process overhead characteristic of the entire system, the characteristic of the HDD 129, and the like.

A recording capacity D/N (bytes) per imaging apparatus in the reserved recording area can be calculated by
D/N=(ΣiDi)/N (2)

The parameters τsi, τwi, and Ti used for these calculations are stored in the HDD 129 upon creating, e.g., a parameter table in advance, and read out to the RAM 123 upon powering on the recording apparatus 120. With this operation, the MPU 121 can refer to these parameters in executing recording operation.

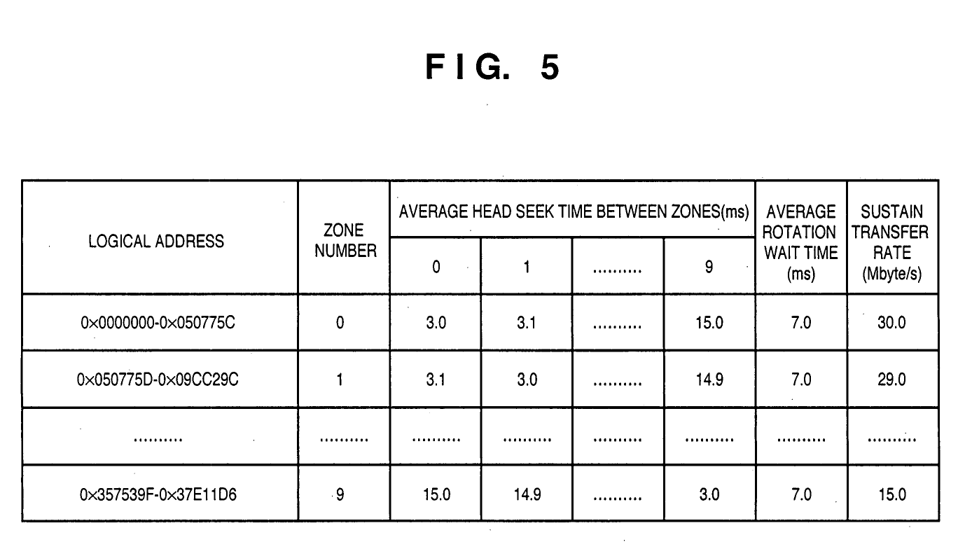

FIG. 5 shows an example of the parameter table. Assume that the logical address (LBA) at the end of a recording area Li-1 is LBA=0x0111111, and the LBA at the start of a recording area Li is LBA=0x0555555 in FIG. 4. In this case, the LBA at the end of the recording area Li-1 belongs to zone 0, and the LBA at the start of the recording area Li belongs to zone 1. Hence, the head seek time τsi=3.1 ms, the rotation wait time τwi=7.0 ms, and the sustain transfer rate Ti=29.0 Mbytes/s.

The first embodiment can, therefore, provide an imaging and recording system capable of recording data at a bit rate as high as possible while dynamically changing the bit rate in accordance with an increase/decrease in the number of imaging apparatuses.

### Second Embodiment

The second embodiment is directed to a form in which the HDD 129 in the first embodiment is replaced with an HDD array (to be referred to as a disk array hereinafter). Only a difference of the second embodiment from the first embodiment will be explained.

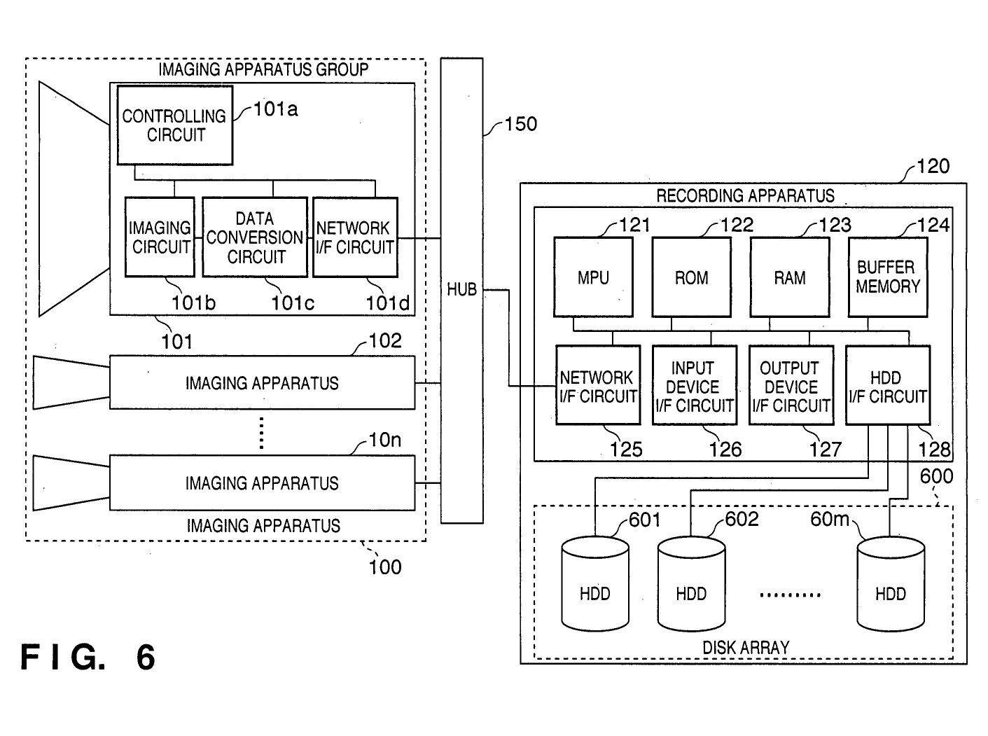

FIG. 6 is a block diagram showing an imaging and recording system according to the second embodiment of the present invention. In FIG. 6, the-same reference numerals as those assigned to respective building components in FIG. 1 denote the same blocks except a “disk array 600” which replaces the “HDD 129”, and a description of these blocks will be omitted. The disk array 600 is made up of m HDDs 601 to 60m, and stores data input/output from/to an input/output device and a network, and data generated by an MPU 121.

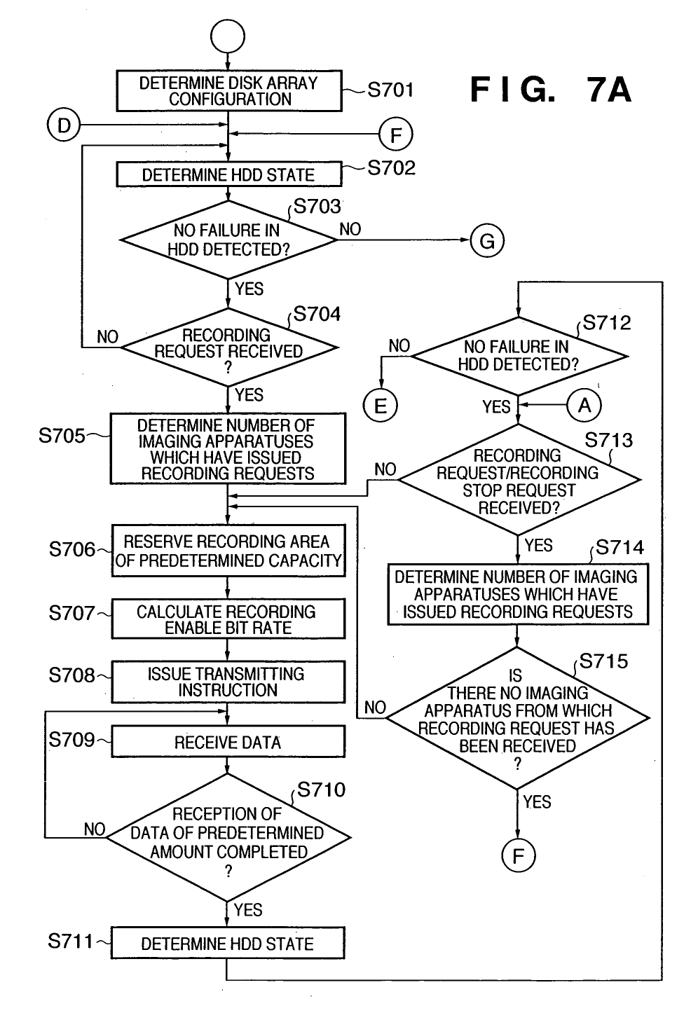

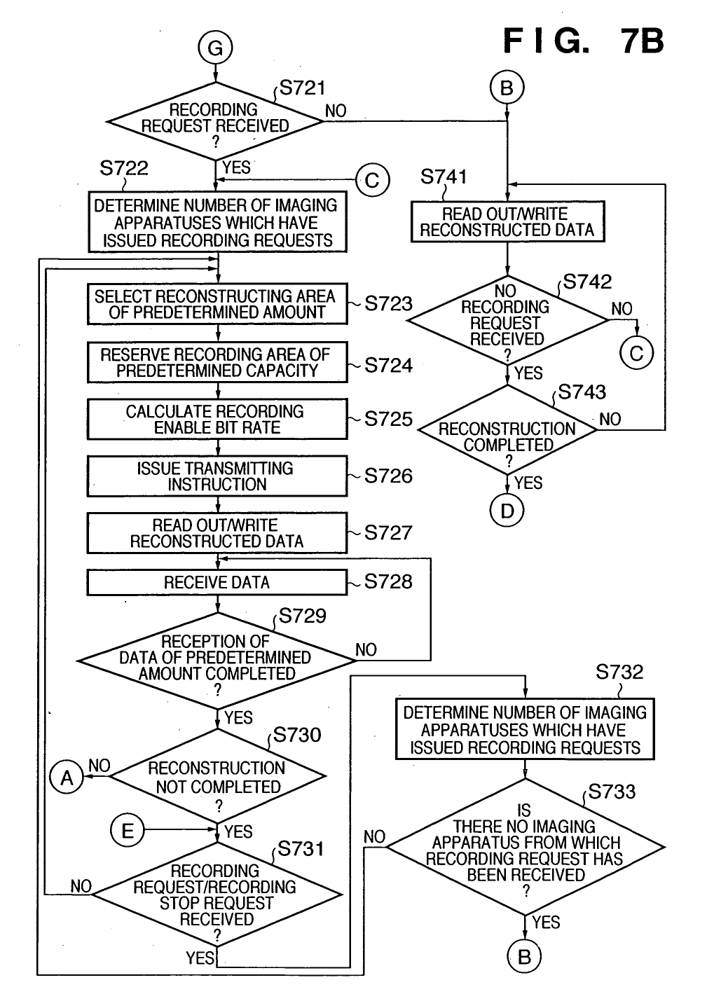

FIGS. 7A and 7B are flowcharts showing operation of a recording apparatus according to the second embodiment of the present invention.

In step S701, the MPU 121 of a recording apparatus 120 determines the configuration of the disk array 600. For descriptive convenience, the disk array 600 is made up of m-1 HDDs 601 to 60m-1 and one spare HDD 60m which are configured in accordance with RAID (Redundant Array of Independent Disks) 5.

In steps S702 to S704, the recording apparatus 120 waits for reception of data recording requests from one or a plurality of imaging apparatuses 101 to 10n while determining the states of the HDDs 601 to 60m-1 by the MPU 121.

If no failure is detected in any of the HDDs 601 to 60m-1 in step S703, the flow advances to step S704. If a failure is detected in any HDD, the flow advances to step S721 to execute a disk array reconstructing process in steps S721 to S733 and S741 to S743. If the recording apparatus 120 receives a data recording request in step S704, the flow advances to step S705.

In step S705, the MPU 121 of the recording apparatus 120 determines the number of imaging apparatuses which have issued data recording requests.

In step S706, the MPU 121 of the recording apparatus 120 searches the storage areas of the HDDs 601 to 60m-1 for an unused area, and reserves a recording area of a predetermined capacity. The capacity of the recording area to be reserved is desirably decided on the basis of the allowance of latency which is generated by a process in steps S706 and S707 (to be described later). Alternatively, the capacity of the recording area to be reserved is desirably decided on the basis of the allowance of overhead which is generated upon executing a process in steps S708 to S713 (to be described later) a plurality of number of times.

In step S707, the MPU 121 of the recording apparatus 120 calculates a recording enable bit rate and recording capacity per imaging apparatus in the reserved recording area. A method of calculating the bit rate and recording capacity will be exemplified later.

In step S708, the recording apparatus 120 issues, to the imaging apparatus which has issued the data recording request, a data transmitting instruction containing information on the recording enable bit rate and recording capacity per imaging apparatus in the reserved recording area. The recording enable bit rate is the bit rate of motion picture data to be transmitted from the imaging apparatus. The recording capacity is the data amount of motion picture data to be transmitted from the imaging apparatus. In steps S709 and S710, the recording apparatus 120 keeps receiving data until data of the recording capacity per imaging apparatus in the reserved recording area is received from each imaging apparatus which has issued the data recording request. The recording apparatus 120 stores the received data in a buffer memory 124, and then records the data from the buffer memory 124 to the reserved recording areas in the HDDs 601 to 60m.

If the recording apparatus 120 has received in step S710 data of the recording capacity per imaging apparatus in the reserved recording area from each imaging apparatus which has issued the data recording request, the flow advances to step S711. In step S711, the MPU 121 of the recording apparatus 120 determines the states of the HDDs 601 to 60m-1. If no failure is detected in any of the HDDs 601 to 60m-1 in step S712, the flow advances to step S713; if a failure is detected in any HDD, to step S731.

In step S713, the recording apparatus 120 determines whether new data recording requests or data recording stop requests have arrived from the imaging apparatuses 101 to 10n. This determination can be implemented such that, for example, when the MPU 121 detects a data recording request or data recording stop request in processing a packet coming from a network, the request is buffered.

If neither new data recording request nor data recording stop request has arrived in step S713, the flow returns to step S706. If a new data recording request or data recording stop request has arrived in step S713, the MPU 121 of the recording apparatus 120 determines in steps S714 and S715 the number of imaging apparatuses from which data recording requests have been received at present. If at least one imaging apparatus from which the data recording request has been received exists, the flow returns to step S706. If an imaging apparatus from which the data recording request has been received does not exist, the flow returns to step S702.

In steps S721 to S733 and S741 to S743, the disk array reconstructing process is executed. The following description assumes that an HDD in which a failure is detected is the HDD 601. Reconstruction of the disk array means to read out data recorded on the HDDs 602 to 60m-1, exclusive-OR the readout data, thereby reconstructing data recorded on the HDD 601 in which a failure is detected, and write the data of the HDD 601 on the spare disk 60m.

In step S721, the recording apparatus 120 determines whether data recording requests have arrived from the imaging apparatuses 101 to 10n. If a data recording request has arrived, the flow advances to step S722; if no data recording request has arrived, to step S741.

In step S722, the MPU 121 of the recording apparatus 120 determines the number of imaging apparatuses which have issued data recording requests.

In step S723, the MPU 121 of the recording apparatus 120 searches the disk array 600 for a storage area (stripe) which is not subjected to data reconstruction yet, and selects a storage area of a predetermined amount subjected to data reconstruction at this time. The storage area of the predetermined amount is continuous. As a selected storage area is larger, reconstruction of the disk array 600 is completed in a shorter time, but the recording enable bit rate becomes lower. For this reason, the size of a selected storage area is desirably decided on the basis of the priority of the reconstructing process.

In step S724, the MPU 121 of the recording apparatus 120 searches the storage areas of the HDDs 602 to 60m for an unused area, and reserves a recording area of a predetermined capacity. The capacity of the recording area to be reserved is desirably decided on the basis of the allowance of latency which is generated by a process in steps S724 and S725 (to be described later). Alternatively, the capacity of the recording area to be reserved is desirably decided on the basis of the allowance of overhead which is generated upon executing a process in steps S726 to S731 (to be described later) a plurality of number of times.

In step S725, the MPU 121 of the recording apparatus 120 calculates a recording enable bit rate and recording capacity per imaging apparatus in the reserved recording area. A method of calculating the bit rate and recording capacity will be exemplified later.

In step S726, the recording apparatus 120 issues, to the imaging apparatus which has issued the data recording request, a data transmitting instruction containing information on the recording enable bit rate and recording capacity per imaging apparatus in the reserved recording area. The recording enable bit rate is the bit rate of motion picture data to be transmitted from the imaging apparatus. The recording capacity is the data amount of motion picture data to be transmitted from the imaging apparatus.

In step S727, the recording apparatus 120 reads out data from storage areas of the HDDs 602 to 60m-1 that have been selected in step S723 and correspond to stripes not subjected to data reconstruction yet in the disk array 600. The recording apparatus 120 exclusive-ORs the readout data, and writes the resultant data on the HDD 60m.

In steps S728 and S729, the recording apparatus 120 keeps receiving data until data of the recording capacity per imaging apparatus in the reserved recording area is received from each imaging apparatus which has issued the data recording request. The recording apparatus 120 stores the received data in the buffer memory 124, and then records the data from the buffer memory 124 to the reserved recording areas in the HDDs 602 to 60m.

In step S730, the recording apparatus 120 determines whether the reconstructing process of the disk array 600 is completed. If no reconstructing process is completed, the flow advances to step S731; if the reconstructing process is completed, to step S713.

In step S731, the recording apparatus 120 determines whether new data recording requests or data recording stop requests have arrived from the imaging apparatuses 101 to 10n. This determination can be implemented such that, for example, when the MPU 121 detects a data recording request or data recording stop request in processing a packet coming from a network, the request is buffered.

If neither new data recording request nor data recording stop request has arrived in step S731, the flow returns to step S723. If a new data recording request or data recording stop request has arrived in step S731, the MPU 121 of the recording apparatus 120 determines in steps S732 and S733 the number of imaging apparatuses from which data recording requests have been received at present.

If at least one imaging apparatus from which the data recording request has been received exists in step S733, the flow returns to step S723. If an imaging apparatus from which the data recording request has been received does not exist, the flow returns to step S741.

If no data recording request has arrived in step S721, the recording apparatus 120 waits for reception of data recording requests from one or a plurality of imaging apparatuses 101 to 10n while performing the reconstructing process of the disk array 600.

More specifically, in step S741, the recording apparatus 120 searches the disk array 600 for stripes which are not subjected to data reconstruction yet, and reads out data from storage areas of the HDDs 602 to 60m-1 that correspond to the stripes. The recording apparatus 120 exclusive-ORs the readout data, and writes the resultant data on the HDD 60m.

In step S742, the recording apparatus 120 determines whether data recording requests have arrived from the imaging apparatuses 101 to 10n. If no data recording request has arrived, the flow advances to step S743; if a data recording request has arrived, to step S722.

In step S730, the recording apparatus 120 determines whether the reconstructing process of the disk array 600 is completed. If no reconstructing process is completed, the flow advances to step S741; if the reconstructing process is completed, to step S702.

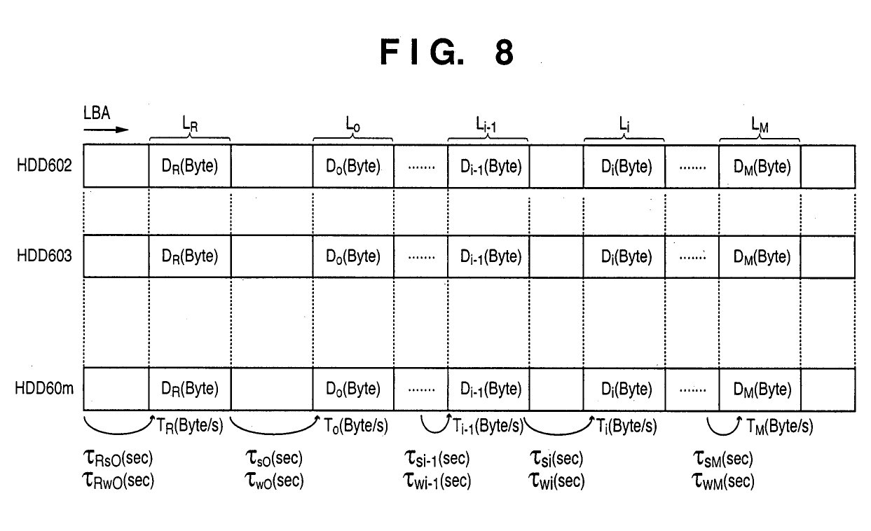

FIG. 8 is a view schematically showing a storage area in the HDD. A method of calculating a recording enable bit rate and recording capacity per imaging apparatus in the reserved recording area in step S707 or S725 will be exemplified with reference to FIG. 8.

In FIG. 8, Li (i=0, 1, . . . , M) represents a continuous recording area which is reserved in step S706 or S724, Di represents the size (bytes) of the recording area Li, and Ti represents a sustain transfer rate (bytes/s) in the recording area Li. Also, τsi represents a head seek time (sec) for moving the recording head of the HDD to a track including a sector on which data is first recorded in the recording area Li, and τwi represents a rotation wait time until a magnetic disk rotates and the recording head reaches a target sector after the recording head moves to a track including the sector on which data is first recorded in the recording area Li.

LR represents each of storage areas of the HDDs 602 to 60m-1 that are selected in step S723 and correspond to stripes not subjected to data reconstruction in the disk array 600. DR represents the size (bytes) of the recording area LR, and TR represents a sustain transfer rate (bytes/s) in the recording area LR. Also, τRsi represents a head seek time (sec) for moving the recording head of the HDD to a track including a sector on which data is first recorded in the recording area LR, and τRwi represents a rotation wait time until a magnetic disk rotates and the recording head reaches a target sector after the recording head moves to a track including the sector on which data is first recorded in the recording area LR.

A recording enable bit rate T/N (bytes/s) per imaging apparatus in the reserved recording area can be substantially calculated by
T/N=(α*(m−2)*ΣiDi/Σi(τsi+τwi+Di/Ti)+τRsi+τRwi+DR/TR))/N (3)
(0<α≦1)

where α is the safety factor which is properly decided from the process overhead characteristic of the entire system, the characteristic of the disk array 600, and the like. In step S707, τRsi+τRwi+DR/TR=0.

A recording capacity D/N (bytes) per imaging apparatus in the reserved recording area can be calculated by
D/N=(m−2)*(ΣiDi)/N (4)

The parameters τsi, τwi, Ti, τRsi, τRwi, and TR used for these calculations are stored in the HDDs 601 to 60m-1 upon creating, e.g., a parameter table as shown in FIG. 5 in advance, and read out to a RAM 123 upon powering on the recording apparatus 120. With this operation, the MPU 121 can refer to these parameters in executing recording operation.

In the second embodiment, the disk array 600 is made up of the m-1 HDDs 601 to 60m-1 and one spare HDD 60m which are configured in accordance with RAID 5, but the present invention is not limited to this. When a disk array is used as a recording medium for motion picture data in the imaging and recording system according to the present invention, a disk array which is configured by another RAID level, unlike the second embodiment, may be adopted.

For example, when the disk array 600 is made up of m HDDs 601 to 60m which are configured by RAID 0, the disk array does not have any redundancy, and processes in steps S702, S703, S711, S712, S721 to S733, and S741 to S743 can be omitted.

The recording enable bit rate T/N (bytes/s) per imaging apparatus in the reserved recording area can be substantially calculated by
T/N=(α*m*ΣiDi/Σi(τsi+τwi+Di/Ti)+τRsi+τRwi+DR/TR))/N (5)
(0<α≦1)

The recording capacity D/N (bytes) per imaging apparatus in the reserved recording area can be calculated by
D/N=m*(ΣiDi)/N (6)

For example, when the disk array 600 is made up of two HDDs 601 and 602 and one spare HDD 603 which are configured by RAID 1, the recording enable bit rate T/N (bytes/s) per imaging apparatus in the reserved recording area can be substantially calculated by

$$T / N = ( α * \sum iDi / \sum i ( τ s i + τ w i + D i / Ti ) + τ Rsi + τ R wi + \\ DR / TR ) ) / N \\ ( 0 < α \leq 1 ) \qquad ( 7 )$$

The recording capacity D/N (bytes) per imaging apparatus in the reserved recording area can be calculated by
D/N=(ΣiDi)/N (8)

The second embodiment can, therefore, provide an imaging and recording system which uses a disk array as a recording medium for motion picture data, and can record data at a bit rate as high as possible while dynamically changing the bit rate in accordance with the state (during a reconstructing process or not) of the disk array.

According to the present invention, in an imaging and recording system having an imaging apparatus and recording apparatus, the recording apparatus instructs the imaging apparatus on the bit rate of image data to be output from the imaging apparatus, on the basis of a bit rate which allows recording on a disk type storage medium of the recording apparatus. With this operation, there can be provided an imaging and recording system capable of recording an image sensed by the imaging apparatus at an image quality as high as possible while preventing a recording failure such as frame omission.

According to an invention defined in claim 2, in the invention defined in claim 1, the recording apparatus instructs, on the basis of a bit rate which allows recording in a recording area reserved in the disk type recording medium, the imaging apparatus on the bit rate of image data to be output from the imaging apparatus. The recording apparatus can dynamically change the bit rate of image data to be output from the imaging apparatus in accordance with the reserved recording area.

According to an invention defined in claim 3 or 4, in the invention defined in claim 1 or 2, the bit rate of image data to be output from the imaging apparatus can be dynamically changed in accordance with the number of imaging apparatuses which request the recording apparatus to record image data. That is, an image sensed by the imaging apparatus can always be recorded at an image quality as high as possible at this time regardless of an increase/decrease in the number of imaging apparatuses which request the recording apparatus to record image data.

According to the present invention, the invention defined in claim 1 or 2 can be applied to an imaging and recording system which uses a disk array as a disk type recording medium.

According to an invention defined in claim 7 or 8, in the invention defined in claim 5 or 6, when the disk array is configured with redundancy, the bit rate of image data to be output from the imaging apparatus can be dynamically changed on the basis of a state representing whether the disk array is during a reconstructing process. That is, an image sensed by the imaging apparatus can always be recorded at an image quality as high as possible at this time regardless of whether the disk array is in reconstruction.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-277756 filed on Sep. 24, 2004, the entire contents of which are hereby incorporated by reference herein.

What is claimed is:

1. An imaging and recording system including an imaging apparatus and a recording apparatus, wherein
said imaging apparatus comprises:
first receiving means for receiving an output bit rate instruction which is issued by said recording apparatus and instructs said imaging apparatus on a first bit rate of image data to be output from said imaging apparatus; and
output means for converting a sensed image into image data of a predetermined bit rate on the basis of the output bit rate instruction received by said first receiving means, and outputting the image data to said recording apparatus, and
said recording apparatus comprises:
a disk type recording medium;
first issue means for calculating a second bit rate recording enable on said disk type recording medium, calculating the first bit rate of image data to be output from said imaging apparatus on the basis of the second bit rate, and issuing the output bit rate instruction to said imaging apparatus; and
recording means for receiving the image data output from said imaging apparatus and recording the image data on said disk type recording medium.

2. The system according to claim 1, wherein
said imaging apparatus further comprises second receiving means for receiving an output data amount instruction which is issued by said recording apparatus and instructs said imaging apparatus on a first data amount of image data to be output from said imaging apparatus,
said output means outputs image data at the predetermined bit rate by a data amount based on the output data amount instruction received by said second receiving means,
said recording apparatus further comprises
reserving means for reserving a recording area of a predetermined amount in said disk type recording medium, and
second issue means for calculating a data amount of image data to be output from said imaging apparatus on the basis of a recording capacity of the recording area of the predetermined amount that is reserved by said reserving means, and issuing the output data amount instruction to said imaging apparatus,
said first issue means calculates a second bit rate which allows recording on said disk type recording medium in the recording area of the predetermined amount that is reserved by said reserving means, and
said recording means records image data received from said imaging apparatus in the recording area of the predetermined amount that is reserved by said reserving means.

3. The system according to claim 1, wherein
said imaging apparatus further comprises third issue means for issuing an image recording request which requests said recording apparatus to record image data output from said imaging apparatus,
said recording apparatus further comprises third receiving means for receiving the image recording request issued by said imaging apparatus, and
said first issue means calculates the first bit rate of image data to be output from said imaging apparatus on the basis of the number of imaging apparatuses which have issued the image recording request received by said third receiving means.

4. The system according to claim 2, wherein
said imaging apparatus further comprises third issue means for issuing an image recording request which requests said recording apparatus to record image data output from said imaging apparatus,
said recording apparatus further comprises third receiving means for receiving the image recording request issued by said imaging apparatus,
said first issue means calculates the first bit rate of image data to be output from said imaging apparatus on the basis of the number of imaging apparatuses which have issued the image recording request received by said third receiving means, and
said second issue means calculates the data amount of image data to be output from said imaging apparatus on the basis of the number of imaging apparatuses which have issued the image recording request received by said third receiving means.

5. The system according to claim 1, wherein
said disk type recording medium includes a plurality of disk type recording media, and
said first issue means calculates the second bit rate which allows recording on said disk type recording medium on the basis of a configuration of said plurality of disk type recording media, and calculates the first bit rate of image data to be output from said imaging apparatus on the basis of the second bit rate.

6. The system according to claim 2, characterized in that
said disk type recording medium includes a plurality of disk type recording media,
said first issue means calculates the second bit rate which allows recording on said disk type recording medium on the basis of a configuration of said plurality of disk type recording media, and calculates the first bit rate of image data to be output from said imaging apparatus on the basis of the second bit rate, and
said second issue means calculates the data amount of image data to be output from said imaging apparatus on the basis of the configuration of said plurality of disk type recording media.

7. The system according to claim 5, wherein
said plurality of recording media are configured with redundancy, and
said first issue means calculates the second bit rate which allows recording on said disk type recording medium on the basis of a state representing whether said plurality of disk type recording media are during a reconstructing process, and calculates the first bit rate of image data to be output from said imaging apparatus on the basis of the second bit rate.

8. The system according to claim 6, wherein
said plurality of recording media are configured with redundancy,
said first issue means calculates the second bit rate which allows recording on said disk type recording medium on the basis of a state representing whether said plurality of disk type recording media are during a reconstructing process, and calculates the first bit rate of image data to be output from said imaging apparatus on the basis of the second bit rate, and
said second issue means calculates the data amount of image data to be output from said imaging apparatus on the basis of the state representing whether said plurality of disk type recording media are during a reconstructing process.

9. An imaging apparatus which is connected to a recording apparatus, comprising:
receiving means for receiving an output bit rate instruction which is issued by the recording apparatus and instructs the imaging apparatus on a first bit rate of image data to be output from the imaging apparatus; and
output means for converting a sensed image into image data of a predetermined bit rate on the basis of the output bit rate instruction received by said receiving means, and outputting the image data to the recording apparatus,
wherein the first bit rate is calculated on the basis of a second bit rate which is calculated by the recording apparatus and allows recording on a disk type recording medium.

10. A recording apparatus which is connected to an imaging apparatus, comprising:
a disk type recording medium;
issue means for calculating a second bit rate which allows recording on said disk type recording medium, calculating a first bit rate of image data to be output from the imaging apparatus on the basis of the second bit rate, and issuing an output bit rate instruction to the imaging apparatus; and
recording means for receiving the image data output from the imaging apparatus and recording the image data on said disk type recording medium.

11. A method of controlling an imaging apparatus which is connected to a recording apparatus, comprising:
a receiving step of receiving an output bit rate instruction which is issued by the recording apparatus and instructs the imaging apparatus on a first bit rate of image data to be output from the imaging apparatus; and
an output step of converting a sensed image into image data of a predetermined bit rate on the basis of the output bit rate instruction received in the receiving step, and outputting the image data to the recording apparatus,
wherein the first bit rate is calculated on the basis of a second bit rate which is calculated by the recording apparatus and allows recording on a disk type recording medium.

12. A method of controlling a recording apparatus which is connected to an imaging apparatus and has a disk type recording medium, comprising:
an issue step of calculating a second bit rate recording enable on the disk type recording medium, calculating a first bit rate of image data to be output from the imaging apparatus on the basis of the second bit rate, and issuing an output bit rate instruction to the imaging apparatus; and
a recording step of receiving the image data output from the imaging apparatus and recording the image data on the disk type recording medium.

13. A program for causing a computer to execute control of an imaging apparatus which is connected to a recording apparatus, comprising:
a receiving step of receiving an output bit rate instruction which is issued by the recording apparatus and instructs the imaging apparatus on a first bit rate of image data to be output from the imaging apparatus; and
an output step of converting a sensed image into image data of a predetermined bit rate on the basis of the output bit rate instruction received in the receiving step, and outputting the image data to the recording apparatus,
wherein the first bit rate is calculated on the basis of a second bit rate which is calculated by the recording apparatus and allows recording on a disk type recording medium.

14. A program for causing a computer to execute control of a recording apparatus which is connected to an imaging apparatus and has a disk type recording medium, comprising:
an issue step of calculating a second bit rate recording enable on the disk type recording medium, calculating a first bit rate of image data to be output from the imaging apparatus on the basis of the second bit rate, and issuing an output bit rate instruction to the imaging apparatus; and
a recording step of receiving the image data output from the imaging apparatus and recording the image data on the disk type recording medium.
